(19) United States
(12) Patent Application Publication
(10) Pub. No.: US 2026/0159614 A1
(43) Pub. Date: Jun. 11, 2026

(54) POLYMER CARRYING SPECIFIC EPOXY FUNCTIONAL PENDANT GROUPS

(71) Applicant: COMPAGNIE GENERALE DES ETABLISSEMENTS MICHELIN, Clermont-Ferrand (FR)

(72) Inventors: FRANCOIS JEAN-BAPTISTE-DIT-DOMINIQUE, Clermont-Ferrand (FR); KAHINA MAMMERI, Clermont-Ferrand (FR)

(21) Appl. No.: 18/722,892

(22) PCT Filed: Dec. 19, 2022
(86) PCT No.: PCT/EP2022/086550

§ 371 Date: Jun. 21, 2024

(30) Foreign Application Priority Data
Dec. 23, 2021 (FR) 2114418

(51) Int. Cl. C08C 19/34; B60C 1/00; C08C 19/10; C08C 19/22; C08K 3/04; C08K 3/06; C08K 3/36

(52) U.S. Cl. CPC C08C 19/34; B60C 1/00; C08C 19/10; C08C 19/22; C08K 3/04; C08K 3/06; C08K 3/36; C08K 2201/006

(57) ABSTRACT

A polymer comprises one or more diene units and bears along the main polymer chain one or more pendent groups of the following formula (I):

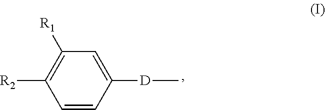

in which: D represents a group of attachment to the main polymer chain; R₁ represents a chemical group selected from the group consisting of —OCH₃, —OCH₂CH₃ and —OR₃; R₂ represents a chemical group selected from the group consisting of —OCH₃ and —OR₃, provided that R₁ or R₂ is —OR₃; R₃ represents a chemical group of formula (II):

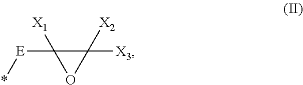

in which E represents a divalent C₁-C₁₂ hydrocarbon group optionally comprising one or more heteroatoms; X₁, X₂, X₃, which may be identical or different, represent a hydrogen atom, a C₁-C₆ alkyl or a C₆-C₁₄ aryl; and the symbol * represents the attachment of the chemical group of formula (II) to the oxygen atom.

The invention relates to a polymer bearing epoxy functional pendent groups, and also to a process for preparing these polymers and to the uses thereof in particular for elastomeric compositions, for semi-finished articles for tyres and for tyres.

In the industrial field, mixtures of polymers with fillers are often used. In order for such mixtures to have good properties, means for improving the dispersion of the fillers within the polymers are continually being sought.

In particular, for elastomeric compositions intended for tyre manufacture, manufacturers are constantly in search of filled elastomeric compositions which have good mechanical properties, such as reinforcement, and a hysteresis that is as low as possible. Specifically, reduction of the hysteresis of an elastomeric composition is favourable for reducing the rolling resistance of a tyre and thus reducing the fuel consumption of a vehicle driving with such tyres.

It is known that, generally, in order to obtain the optimum reinforcing properties conferred by a reinforcing filler, it is advisable for the latter to be present in the elastomeric matrix in a final form which is both as finely divided as possible and as homogeneously distributed as possible.

Many solutions have already been tried for achieving good dispersion of the reinforcing filler in an elastomeric composition and for obtaining rubber compositions having good reinforcing properties.

Mention may in particular be made of the use, in an elastomeric composition, of polymers having a structure which has been modified by means of functionalization agents, coupling agents or star-branching agents with the aim of obtaining a good interaction between the polymer thus modified and the reinforcing filler, whether this be carbon black or a reinforcing inorganic filler.

For example, the document WO2019102126A1 discloses a styrene/butadiene copolymer onto which has been grafted the functionalization agent 2,4,6-trimethyl-3-(oxiran-2-ylmethoxy)benzonitrile oxide. This elastomer thus grafted makes it possible to obtain an elastomeric composition having improved hysteresis properties compared to an elastomeric composition comprising an ungrafted styrene/butadiene copolymer.

Since fuel savings and the need to protect the environment have become a priority, it has proved necessary to produce tyres having a rolling resistance which is as low as possible, that is to say comprising elastomeric compositions having a hysteresis that is as low as possible.

Obtaining an elastomeric composition with a hysteresis that is as low as possible, while at the same time maintaining a good performance level for the other properties, such as reinforcement and stiffness, is an ongoing challenge for tyre manufacturers. Indeed, it is known that a decrease in the hysteresis of elastomeric compositions is accompanied by a decrease in the cured stiffness. However, a tread must be stiff enough to ensure a good level of road behaviour of the tyre.

There is therefore an ongoing need to have available polymers having hysteresis properties that are further improved compared to the prior art polymers, without this improvement being obtained at the expense of the stiffness properties.

One aim of the present invention is therefore that of proposing novel polymers possessing an improvement in the rolling resistance/stiffness compromise.

Pursuing its research, the applicant has discovered, surprisingly, that the presence of particular functional pendent groups in polymers, once incorporated into elastomeric compositions, in particular usable for the manufacture of tyres, leads to the obtaining of an improved rolling resistance/stiffness compromise compared to prior art polymers incorporated into elastomeric compositions.

Thus, a first subject of the present invention relates to a polymer comprising one or more diene units and bearing along the main polymer chain one or more pendent groups of the following formula (I):

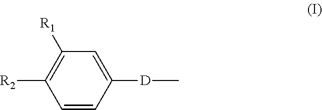

in which:
   D represents a group of attachment to the main polymer chain;
   R₁ represents a chemical group selected from the group consisting of —OCH₃, —OCH₂CH₃ and —OR₃;
   R₂ represents a chemical group selected from the group consisting of —OCH₃ and —OR₃;
   provided that R₁ or R₂ is —OR₃;
   R₃ represents a chemical group of formula (II)

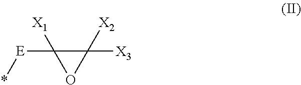

in which E represents a divalent C1-C12 hydrocarbon group optionally comprising one or more heteroatoms;
X₁, X₂, X₃, which may be identical or different, represent a hydrogen atom, a C1-C6 alkyl or a C6-C14 aryl;
the symbol * represents the attachment of the chemical group of formula (II) to the oxygen atom.

Preferentially, the pendent groups are randomly distributed along the main polymer chain.

Preferentially, in the polymer, the molar content of pendent groups of formula (I) is within a range extending from 0.05% to 15%, preferably from 0.05% to 10%, more preferentially from 0.07% to 5%.

Preferentially, the polymer is a diene elastomer.

Preferentially, the polymer is selected from the group of elastomers consisting of ethylene/propylene/diene monomer copolymers, butyl rubbers, natural rubber, synthetic polyisoprenes, polybutadienes, butadiene copolymers, isoprene copolymers, and mixtures of these elastomers.

Preferentially, R₁ represents a chemical group selected from the group consisting of —OCH₃ and —OCH₂CH₃; and R₂ is —OR₃.

Preferentially, E represents a C1-C12 alkanediyl, preferably a C1-C10 alkanediyl, more preferentially a C1-C9 alkanediyl; preferably E is selected from the group consisting of methanediyl, ethanediyl and propanediyl.

Preferentially, X₁, X₂, X₃, which may be identical or different, are selected from the group consisting of a hydrogen atom, C1-C6 alkyls and phenyl.

Preferentially, X₁, X₂, X₃, which are identical, are a hydrogen atom.

Preferentially, the pendent group of formula (I) is the pendent group of formula (Ia1)

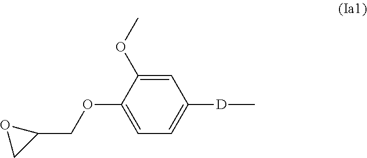

Preferentially, the attachment group D results from the reaction of a nitrile oxide function with a diene unit of the polymer.

Another subject of the present invention relates to a process for preparing a polymer by modification of an initial diene polymer, said process comprising a step of grafting on said diene polymer with a compound from which is derived the pendent group of formula (I) defined above.

Another subject of the present invention relates to an elastomeric composition based on at least one polymer defined above or on a polymer capable of being obtained by a process above, on at least one reinforcing filler and on at least one crosslinking agent.

Another subject of the present invention relates to a semi-finished article for a tyre comprising at least one polymer defined above or a polymer capable of being obtained by a process defined above or a composition defined above.

Another subject of the present invention relates to a tyre comprising at least one polymer defined above or a polymer capable of being obtained by a process according as described above or comprising at least one elastomeric composition defined above or at least one semi-finished article for a tyre above.

The invention and its advantages will be easily understood in the light of the description and exemplary embodiments which follow.

In the present text, unless expressly indicated otherwise, all the percentages (%) indicated are mass percentages (%).

Moreover, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

The compounds mentioned in the description may be of fossil origin or biobased. In the latter case, they may be partially or completely derived from biomass or obtained from renewable starting materials derived from biomass. Of course, the compounds mentioned may also originate from the recycling of already-used materials, that is to say that they may partially or completely result from a recycling process, or else be obtained from starting materials which themselves result from a recycling process. This notably relates to polymers, plasticizers, fillers, etc.

The expression “composition based on” should be understood to mean a composition comprising the mixture and/or the product of the in situ reaction of the various constituents used, some of these constituents being able to react and/or being intended to react with one another, at least partially, during the various phases of manufacture of the composition; it thus being possible for the composition to be in the completely or partially crosslinked state or in the non-crosslinked state.

The expression “part by weight per hundred parts by weight of elastomer” (or phr) should be understood as meaning, for the purposes of the present invention, the part by mass per hundred parts by mass of elastomer.

When reference is made to a “predominant” compound, this is understood to mean, for the purposes of the present invention, that this compound is predominant among the compounds of the same type in the composition, that is to say that it is the one which represents the greatest amount by mass among the compounds of the same type. Thus, for example, a predominant elastomer is the elastomer representing the greatest mass relative to the total mass of the elastomers in the composition. In the same way, a “predominant” filler is that representing the greatest mass among the fillers of the composition. By way of example, in a system comprising just one elastomer, the latter is predominant within the meaning of the present invention; and in a system comprising two elastomers, the predominant elastomer represents more than half of the mass of the elastomers, preferably more than 51% by mass of the total mass of the elastomers.

The term “1,3-dipolar compound” is understood according to the definition given by the IUPAC. By definition, a 1,3-dipolar compound comprises a dipole.

For the purposes of the present invention, the term “hydrocarbon chain” means a chain comprising one or more carbon atoms and one or more hydrogen atoms.

The expression “Ci-Cj alkyl” denotes a linear, branched or cyclic hydrocarbon group comprising from i to j carbon atoms; i and j being integers.

The expression “Ci-Cj aryl” denotes an aromatic group comprising from i to j carbon atoms; i and j being integers.

The term “Ci-Cj alkanediyl” is understood to mean a hydrocarbon group derived from a Ci-Cj alkane as defined above and in which two hydrogen atoms have been removed. An alkanediyl is therefore a divalent group.

In the remainder of the text, the term “content of pendent groups of formula (I)”, including preferred forms thereof, present in the polymer, preferably in the diene elastomer, expressed as molar percentage, is understood to mean the number of moles of pendent groups of formula (I) present per hundred moles of constituent unit constituting the polymer, preferably the diene elastomer, regardless of whether these be diene or non-diene units. For example, if the content of pendent groups of formula (I), or of preferred forms thereof, relative to an SBR (styrene/butadiene rubber) is 0.20 mol %, this means that there will be 0.20 units derived from pendent groups of formula (I) (or preferred forms) per 100 constituent units of SBR. The molar content of pendent groups of formula (I) can be determined by conventional polymer analysis methods, such as for example ¹H NMR analysis.

### Diene Polymer:

The polymer of the invention is a polymer comprising one or more diene units and bearing along the main polymer chain one or more pendent groups of formula (I):

As is known, a polymer generally comprises at least one main polymer chain. This polymer chain may be termed the main chain as long as all the other chains of the polymer are considered to be pendent chains, as mentioned in the document “Glossary of basic terms in polymer science” (IUPAC recommendations 1996), PAC, 1996, 68, 2287, page 2294.

For the purposes of the present invention, the term “pendant group” is understood to mean a side group of the polymer chain. For the purposes of the present invention, the term “side group” denotes a substituent which is not an oligomer or a polymer (see also the definition in “Glossary of basic terms in polymer science” (IUPAC recommendations 1996), PAC, 1996, 68, 2287, page 2297).

For the purposes of the present invention, the expression “polymer comprising one or more diene units” is understood to mean any natural or synthetic polymer at least partly consisting (i.e. a homopolymer or a copolymer) of diene monomer units (monomers bearing two conjugated or non-conjugated carbon-carbon double bonds). Such a polymer can also be referred to as a diene polymer.

The term “diene polymer which can be used in the invention” is understood more particularly to mean:
any homopolymer of a conjugated or non-conjugated diene monomer having from 4 to 18 carbon atoms;
any copolymer of a conjugated or non-conjugated diene having from 4 to 18 carbon atoms and of at least one other monomer.

The other monomer can be ethylene, an olefin or a conjugated or non-conjugated diene.

Suitable as conjugated dienes are conjugated dienes having from 4 to 12 carbon atoms, especially 1,3-dienes, such as, in particular, 1,3-butadiene and isoprene.

Suitable as non-conjugated dienes are non-conjugated dienes having from 6 to 12 carbon atoms, such as 1,4-hexadiene, ethylidenenorbornene or dicyclopentadiene.

Suitable as olefins are vinylaromatic compounds having from 8 to 20 carbon atoms and aliphatic α-monoolefins having from 3 to 12 carbon atoms.

Suitable as vinylaromatic compounds are, for example, styrene, ortho-, meta- or para-methylstyrene, the “vinyltoluene” commercial mixture or para-(tert-butyl)styrene.

Suitable as aliphatic α-monoolefins are in particular acyclic aliphatic α-monoolefins having from 3 to 18 carbon atoms.

More particularly, the diene polymer is:
any homopolymer of a conjugated diene monomer, in particular any homopolymer obtained by polymerization of a conjugated diene monomer having from 4 to 12 carbon atoms;
any copolymer obtained by copolymerization of one or more conjugated dienes with each other or with one or more vinylaromatic compounds having from 8 to 20 carbon atoms;
a copolymer of isobutene and of isoprene (butyl rubber) and also the halogenated versions, in particular chlorinated or brominated versions, of this type of copolymer;
any copolymer obtained by copolymerization of one or more conjugated or non-conjugated dienes with ethylene, an α-monoolefin or a mixture thereof, such as, for example, the elastomers obtained from ethylene, from propylene with a non-conjugated diene monomer of the abovementioned type.

Preferably, the polymer which can be used in the context of the present invention is a diene elastomer. When the polymer is a diene elastomer, the main polymer chain is of course a main elastomer chain.

The term “diene elastomer” (or, without distinction, “diene rubber”), whether natural or synthetic, should be understood, in a known way, as meaning an elastomer consisting, at least in part (i.e., a homopolymer or a copolymer), of diene monomer units (monomers bearing two conjugated or non-conjugated carbon-carbon double bonds).

These diene elastomers can be classified into two categories: “essentially unsaturated” or “essentially saturated”. The term “essentially unsaturated” is generally understood to mean a diene elastomer derived at least in part from conjugated diene monomers having a content of units of diene origin (conjugated dienes) which is greater than 15% (mol %); thus, diene elastomers such as butyl rubbers or copolymers of dienes and of α-olefins of EPDM type do not fall under the preceding definition and may especially be termed “essentially saturated” diene elastomers (low or very low content, always less than 15% (mol %), of units of diene origin).

The term “diene elastomer that can be used in the context of the present invention” is understood particularly to mean:

Preferentially, the diene elastomer is selected from the group consisting of ethylene/propylene/diene monomer (EPDM) copolymers, butyl rubbers, natural rubber (NR), synthetic polyisoprenes (TRs), polybutadienes (BRs), butadiene copolymers, isoprene copolymers and the mixtures of these elastomers.

Preferentially, the diene elastomer is selected from the group consisting of ethylene/propylene/diene monomer (EPDM) copolymers, natural rubber (NR), synthetic polyisoprenes (TRs), polybutadienes (BRs), butadiene/styrene copolymers (SBRs), ethylene/butadiene copolymers (EBRs), isoprene/butadiene copolymers (BIRs) or isoprene/butadiene/styrene copolymers (SBIRs), isobutene/isoprene copolymers (butyl rubber IIR), isoprene/styrene copolymers (SIRs), and mixtures of these elastomers.

Preferentially, the diene elastomer is selected from the group consisting of natural rubber, synthetic polyisoprenes, polybutadienes, butadiene copolymers, isoprene copolymers and mixtures of these elastomers.

More preferentially, the diene elastomer is selected from the group consisting of natural rubber, synthetic polyisoprenes, polybutadienes, butadiene/styrene copolymers, ethylene/butadiene copolymers, isoprene/butadiene copolymers, isoprene/butadiene/styrene copolymers, isobutene/isoprene copolymers, isoprene/styrene copolymers, and mixtures of these elastomers.

The polymers, preferably the diene elastomers, can have any microstructure, which depends on the polymerization conditions used. These polymers, preferably these diene elastomers, may be, for example, block, random, sequential or microsequential and may be prepared in dispersion, in emulsion or in solution. They may be coupled and/or star-branched, for example by means of a silicon or tin atom which connects the polymer chains together. They are preferably random polymers, more preferentially random diene elastomers.

### Pendent Group of Formula (I)

As mentioned above, the polymer, preferably the diene elastomer, of the invention comprising one or more diene units bears along the main polymer chain one or more pendent groups of the following formula (I):

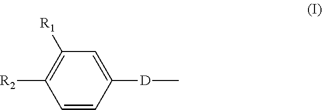

in which:
D represents a group of attachment to the main polymer chain;
R₁ represents a chemical group selected from the group consisting of —OCH₃, —OCH₂CH₃ and —OR₃;
R₂ represents a chemical group selected from the group consisting of —OCH₃ and —OR₃;
provided that R₁ or R₂ is —OR₃;
R₃ represents a chemical group of formula (II):

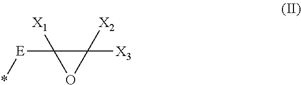

in which E represents a divalent C1-C12 hydrocarbon group optionally comprising one or more heteroatoms;
X₁, X₂, X₃, which may be identical or different, represent a hydrogen atom, a C1-C6 alkyl or a C6-C14 aryl;
the symbol * represents the attachment of the group of formula (II) to the oxygen atom.

Preferentially, said pendent groups of formula (I) are randomly distributed along the main polymer chain.

In particular, the pendent groups of formula (I) are especially located elsewhere other than at the ends of the main polymer chain.

Preferentially, the molar content of pendent groups of formula (I) is within a range extending from 0.05% to 15%, preferably from 0.05% to 10%, more preferentially from 0.07% to 5%.

More advantageously, among the pendent groups of formula (I), the pendent groups that are more particularly preferred are those of formula (Ia)

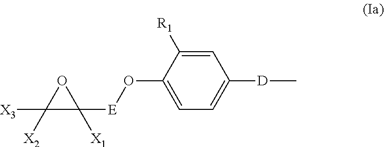

in which:
D represents a group of attachment to the main polymer chain;
R₁ represents a chemical group selected from the group consisting of —OCH₃ and —OCH₂CH₃; more preferentially R₁ represents —OCH₃;
E represents a divalent C1-C12 hydrocarbon group optionally comprising one or more heteroatoms; and
X₁, X₂, X₃, which may be identical or different, represent a hydrogen atom, a C1-C6 alkyl or a C6-C14 aryl.

Thus, a set of pendent groups of formula (I) that are particularly preferred are those for which R₁ represents a chemical group selected from the group consisting of —OCH₃ and —OCH₂CH₃ and R₂ is —OR₃. In other words, these pendent groups are those corresponding to the set formed by the compounds of preferred formula (Ia).

Preferentially, in the pendent groups of formula (I), the provision “R₁ or R₂ is —OR₃” means that if R₁ is —OCH₃ or —OCH₂CH₃ then R₂ is —OR₃; or if R₁ is —OR₃ then R₂ is —OCH₃. There is necessarily one (1) (and only 1) —OR₃ group in these compounds, either as substituent R₁ or as substituent R₂.

In the pendent groups of formulae (I) and (Ia), E represents a divalent C1-C12 hydrocarbon group that may optionally contain one or more heteroatoms. For the purposes of the present invention, the term “divalent hydrocarbon group” is understood to mean a spacer group (or linking group) forming a bridge between the oxygen atom attached to the aromatic ring and the epoxy ring bearing groups X₁, X₂, X₃; this spacer group E comprising from 1 to 12 carbon atoms and optionally being able to contain one or more heteroatoms such as for example N, O and S. This spacer group may be a, preferably saturated, linear or branched C1-C12 hydrocarbon chain which may optionally contain one or more heteroatoms such as for example N, O and S. Said hydrocarbon chain may optionally be substituted, provided that the substituents do not react with the group D and the epoxy ring as defined above.

Preferentially, in the pendent groups of formulae (I) and (Ia), E represents a divalent C1-C10, preferably C1-C9, hydrocarbon group that may optionally contain one or more heteroatoms such as for example N, O and S.

More preferentially, in the pendent groups of formulae (I) and (Ia), E represents a C1-C12 alkanediyl, preferably a C1-C10 alkanediyl, more preferentially a C1-C9 alkanediyl. More preferentially still, E is selected from the group consisting of methanediyl, ethanediyl and propanediyl.

Preferentially, in the pendent groups of formulae (I) and (Ia), X₁, X₂, X₃, which may be identical or different, are selected from the group consisting of a hydrogen atom, C1-C6 alkyls and C6-C14 aryls.

Preferentially, in the pendent groups of formulae (I) and (Ia), X₁, X₂, X₃, which may be identical or different, are selected from the group consisting of a hydrogen atom, C1-C6 alkyls and phenyl.

Preferentially, in the pendent groups of formulae (I) and (Ia), X₁, X₂, X₃, which may be identical or different, are selected from the group consisting of a hydrogen atom, C1-C3 alkyls and phenyl.

According to a preferred embodiment of the invention, in the pendent groups of formulae (I) and (Ia), X₁, X₂, X₃, which are identical, represent a hydrogen atom.

According to another preferred embodiment of the invention, in the pendent groups of formulae (I) and (Ia), X₁ and X₂ represent a hydrogen atom and X₃ represents a phenyl.

According to another embodiment of the invention, in the pendent groups of formulae (I) and (Ia), X₃ is a hydrogen atom, and X₁ and X₂, which may be identical or different, represent a hydrogen atom or a methyl.

As indicated above, among the pendent groups of formula (I), particular preference is given to the pendent groups of formula (Ia)

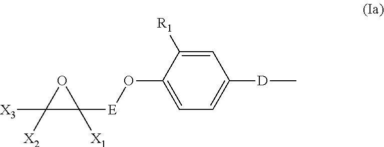

in which:
D represents a group of attachment to the main polymer chain;
R₁ represents a chemical group selected from the group consisting of —OCH₃ and —OCH₂CH₃; more preferentially R₁ represents —OCH₃;
E represents a divalent C1-C12 hydrocarbon group optionally comprising one or more heteroatoms; and
X₁, X₂, X₃, which may be identical or different, represent a hydrogen atom, a C1-C6 alkyl or a C6-C14 aryl.

Among the pendent groups (Ia), particular preference is given to those for which R₁ represents a chemical group selected from the group consisting of —OCH₃ and —OCH₂CH₃, E represents a C1-C12 alkanediyl, preferably a C1-C10 alkanediyl, more preferentially a C1-C9 alkanediyl and X₁, X₂, X₃, which may be identical or different, are selected from the group consisting of a hydrogen atom, C1-C3 alkyls and phenyl, more preferentially X₁, X₂, X₃, which are identical, are a hydrogen atom.

More preferentially still, the pendent groups of formula (Ia) that are more particularly preferred are those in which R₁ represents —OCH₃, E represents a C1-C12 alkanediyl, preferably a C1-C10 alkanediyl, more preferentially a C1-C9 alkanediyl and X₁, X₂, X₃, which may be identical or different, are selected from the group consisting of a hydrogen atom, C1-C3 alkyls and phenyl, more preferentially X₁, X₂, X₃, which are identical, are a hydrogen atom. More preferentially still, the pendent groups of formula (Ia) that are more particularly preferred are those in which R₁ represents —OCH₃, E represents a C1-C9 alkanediyl and X₁, X₂, X₃, which are identical, are a hydrogen atom. More preferentially still, the pendent groups of formula (Ia) that are more particularly preferred are those in which R₁ represents —OCH₃, E represents a methanediyl, an ethanediyl or a propanediyl and X₁, X₂, X₃, which are identical, are a hydrogen atom.

More preferentially still, among the pendent groups of formulae (I) and (Ia), particular preference is given to those of formula (Ia1)

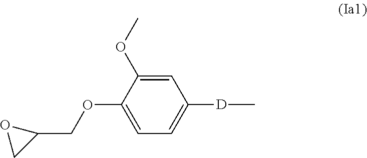

where D is as defined above.

In accordance with formulae (I), (Ia) and (Ia1), the pendant group comprises a chemical group denoted by the symbol D, this chemical group denoting a group of attachment to the main polymer chain. In other words, D makes it possible to covalently bond the phenyl substituted by R₁ and R₂ to the main polymer chain.

The chemical group D is derived from a chemical group D′ which is reactive towards a diene unit of the polymer, that is to say reactive towards a carbon-carbon double bond of the diene monomer. These chemical groups D′ are known and can be, for example, a polymerizable vinyl function or a nitrile oxide function.

In this case where chemical group D′ is a polymerizable vinyl function, this polymerizable vinyl function is derived from a monomer unit of a vinyl monomer that is at least substituted by the phenyl bearing the substituents R₁ and R₂ as defined above. The pendent groups of formula (I), preferably the pendent groups of formula (Ia) and (Ia1), may then be provided along the polymer chain by radical polymerization of a mixture of monomers comprising at least one 1,3-diene monomer and at least one vinyl monomer comprising at least one polymerizable vinyl function and at least substituted by the phenyl bearing the substituents R₁ and R₂ as defined above.

Preferentially, the chemical group D may result from the reaction of a nitrile oxide function that is reactive towards a diene unit of the polymer. The pendent groups of formula (I), preferably the pendent groups of formula (Ia) and (Ia1), may then be provided along the polymer chain by a 1,3-dipolar compound comprising a nitrile oxide function and the phenyl bearing the substituents R₁ and R₂ as defined above. The polymer of the invention is then obtained by grafting a 1,3-dipolar compound onto at least one carbon-carbon double bond of a diene unit of the polymer.

Surprisingly, the polymers of the invention, preferably the diene elastomers, bearing along their main chain one or more pendent groups of formula (I), more preferentially one or more pendent groups of formula (Ia), more preferentially still one or more pendent groups of formula (Ia1), confer the elastomeric compositions containing them with an improved rolling resistance/stiffness compromise and a significant improvement in the reinforcing properties, compared to the prior art compositions.

A subject of the invention is also a process for preparing a polymer according to the invention by modification of an initial diene polymer, said process comprising a step of grafting on said initial diene polymer with a compound from which is derived the pendent group of formula (I), preferably of formula (Ia), more preferentially of formula (Ia1), as defined above.

The grafting of the polymer is carried out by reaction of the initial diene polymer with the reactive group(s) of the chemical function (group D′) from which the chemical group D is derived, in particular with the nitrile oxide function from which the chemical group D is derived. During this reaction, this or these reactive group(s) form(s) covalent bonds with the polymer chain.

Preferentially, the grafting of the compound from which is derived the pendent group of formula (I), of formula (Ia), more preferentially of formula (Ia1), is performed by [3+2] cycloaddition of the reactive group(s) of the function from which the chemical group D is derived and one or more carbon-carbon double bonds of the chain of an initial diene polymer. An example of mechanisms of the [3+2] cycloaddition can be found in the document WO2012007441.

Preferably, the reactive function from which the chemical group D is derived is a nitrile oxide function.

Preferentially, the compound from which the pendent group of formula (I) is derived is a 1,3-dipolar compound, the dipole constituting the reactive group of the function that is reactive towards a diene unit of the polymer from which the group D is derived. More preferentially, the compound from which the pendent group of formula (I) is derived is a nitrile oxide of the following formula (III):

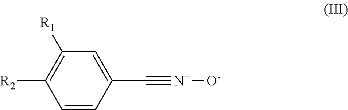

where R₁ and R₂ are as defined above for the pendent groups of formula (I), that is to say where:
   R₁ represents a chemical group selected from the group consisting of —OCH₃, —OCH₂CH₃ and —OR₃;
   R₂ represents a chemical group selected from the group consisting of —OCH₃ and —OR₃;
   provided that R₁ or R₂ is —OR₃;
   R₃ represents a chemical group of formula (II):

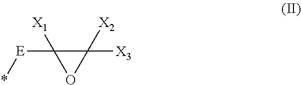

in which E represents a divalent C1-C12 hydrocarbon group optionally comprising one or more heteroatoms;
X₁, X₂, X₃, which may be identical or different, represent a hydrogen atom, a C1-C6 alkyl or a C6-C14 aryl;
the symbol * represents the attachment of the chemical group of formula (II) to the oxygen atom.

The grafting of the compound of formula (III) from which the pendent group of formula (I) is derived may be carried out in bulk, for example in an extruder, an internal mixer or an external mixer, such as an open mill. For example, the grafting can then be performed either at a temperature of the external mixer or of the internal mixer of less than 60° C., followed by a step of grafting reaction under a press or in an oven at temperatures ranging from 80° C. to 200° C., or at a temperature of the external mixer or of the internal mixer of greater than 60° C., without subsequent heat treatment.

The grafting process may also be performed in solution, continuously or batchwise. The polymer thus modified can be separated from its solution by any means known to those skilled in the art and in particular by a steam stripping operation.

Preferentially, in the preparation process according to the invention, the initial diene polymer is an initial diene elastomer, in particular as described above, including in the preferred forms of these elastomers.

Preferentially, when the pendent group is a pendent group of formula (Ia), the compound from which this pendent group is derived is a 1,3-dipolar compound of corresponding formula (IIIa), namely:

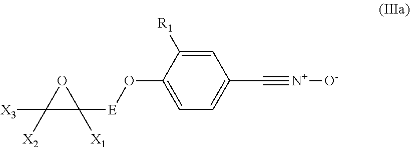

where R₁, X₁, X₂, X₃ and E are as defined above for the pendent groups of formula (III), that is to say where:
   R₁ represents a chemical group selected from the group consisting of —OCH₃ and —OCH₂CH₃; more preferentially R₁ represents —OCH₃;
   E represents a divalent C1-C12 hydrocarbon group optionally comprising one or more heteroatoms; and
   X₁, X₂, X₃, which may be identical or different, represent a hydrogen atom, a C1-C6 alkyl or a C6-C14 aryl.

Preferentially, when the pendent group is a pendent group of formula (Ia1), the compound from which this pendent group is derived is a 1,3-dipolar compound of corresponding formula (IIIa1), namely:

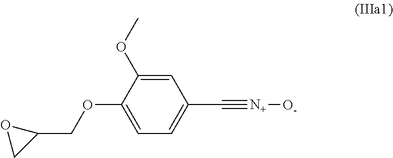

The 1,3-dipolar compounds of formula (IIII) and the preferred forms of formulae (IIIa) and (IIIa1) thereof may notably be obtained by a preparation process comprising at least a reaction (d) of a compound of formula (IV) with an oxidizing agent in the presence of at least one organic solvent SL1 according to the following reaction scheme, to give the compound of formula (III):

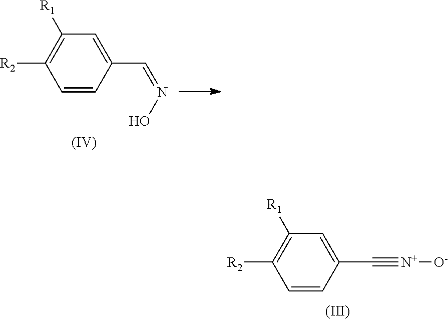

where:
R₁ represents a chemical group selected from the group consisting of —OCH₃, —OCH₂CH₃ and —OR₃;
R₂ represents a chemical group selected from the group consisting of —OCH₃ and —OR₃;
provided that R₁ or R₂ is —OR₃;
R₃ represents a chemical group of formula (II)

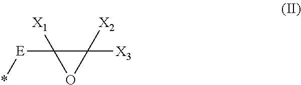

in which E represents a divalent C1-C12 hydrocarbon group optionally comprising one or more heteroatoms;
X₁, X₂, X₃, which may be identical or different, represent a hydrogen atom, a C1-C6 alkyl or a C6-C14 aryl;
the symbol * represents the attachment of the group of formula (II) to the oxygen atom.

The preferred forms of R₁, R₂, E, X₁, X₂ and X₃ as described above also apply to the processes for preparing a compound of formula (III) from a compound of formula (IV).

Those skilled in the art know how to adapt this reaction (d) in order to obtain the preferred 1,3-dipolar compounds of formulae (IIIa) and (IIIa1).

Preferably, in these processes, said oxidizing agent is selected from sodium hypochlorite, N-bromosuccinimide in the presence of a base, N-chlorosuccinimide in the presence of a base, and aqueous hydrogen peroxide solution in the presence of a catalyst. More preferentially, the oxidizing agent is selected from the group consisting of sodium hypochlorite and N-bromosuccinimide in the presence or absence of a base. Preferentially, the base may be triethylamine. More preferentially still, the oxidizing agent is sodium hypochlorite.

Advantageously, the amount of oxidizing agent is from 1 to 5 molar equivalents, preferentially from 1 to 2 molar equivalents, relative to the molar amount of the compound of formula (IV).

Preferentially, the organic solvent SL1 is selected from chlorinated solvents and solvents of ester, ether and alcohol type, more preferentially selected from dichloromethane, trichloromethane, ethyl acetate, butyl acetate, diethyl ether, isopropanol and ethanol, more preferentially still selected from ethyl acetate, trichloromethane, dichloromethane and butyl acetate.

Preferably, the compound of formula (IV) represents from 1% to 30% by weight, preferably from 1% to 20% by weight, relative to the total weight of the combination comprising said compound of formula (IV), said organic solvent SL1 and said oxidizing agent.

Preferentially, the process of the invention comprises, after the reaction (d), a step of recovery of the compound of formula (III).

The compound of formula (IV) may notably be obtained from a preparation process comprising at least a reaction (c) of a compound of formula (V) with hydroxylamine NH₂OH according to the following reaction scheme:

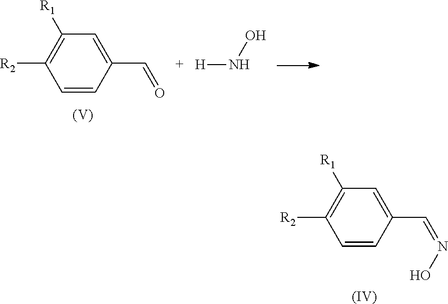

where:
R₁ represents a chemical group selected from the group consisting of —OCH₃, —OCH₂CH₃ and —OR₃;
R₂ represents a chemical group selected from the group consisting of —OCH₃ and —OR₃;
provided that R₁ or R₂ is —OR₃;
R₃ represents a chemical group of formula (II):

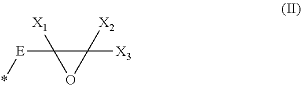

in which E represents a divalent C1-C12 hydrocarbon group optionally comprising one or more heteroatoms;
X₁, X₂, X₃, which may be identical or different, represent a hydrogen atom, a C1-C6 alkyl or a C6-C14 aryl;
the symbol * represents the attachment of the group of formula (II) to the oxygen atom.

The preferred forms of R₁, R₂, E, X₁, X₂ and X₃ as described above also apply to the processes for preparing a compound of formula (IV) from a compound of formula (V).

Those skilled in the art know how to adapt this reaction (c) in order to obtain the preferred 1,3-dipolar compounds of formulae (IIIa) and (IIIa1).

Preferentially, the addition of hydroxylamine in step (c) is carried out at a temperature ranging from 1° C. to 100° C., more preferentially between 20° C. and 70° C.

The hydroxylamine is added either in solution in water or in the form of a salt. When the hydroxylamine is in the form of a salt, it may be selected from the group consisting of hydroxylamine sulfate, hydroxylamine chloride and mixtures thereof. In the case of the use of hydroxylamine in the form of a salt, a base may preferentially be added to the reaction medium. As examples of a base, mention may be made of sodium acetate or triethylamine. The amount of base added may be within a range extending from 1 to 2 molar equivalents relative to the hydroxylamine generated, preferentially from 1 to 1.2 molar equivalents relative to the hydroxylamine generated. The term “hydroxylamine generated” is understood to mean the cation (NH₃OH) of the hydroxylamine salt which is liberated when contacting said salt with water. When a base is used, said base is mixed with the hydroxylamine salt and the mixture is then dissolved in water. Preferentially, the hydroxylamine is brought into contact with the compound of formula (Ic) in the form of a hydroxylamine salt in the presence of a base, such as sodium acetate or triethylamine.

Preferentially, the process of the invention comprises, after the reaction (c), a step of recovery of the compound of formula (IV).

The compound of formula (V) may be obtained by a preparation process comprising at least a reaction (b) of the compound of formula (VI) with a compound of formula (VII) in the presence of at least one phase transfer agent and at a temperature ranging from 10° C. to 120° C., preferentially from 20° C. to 100° C., according to the following reaction scheme:

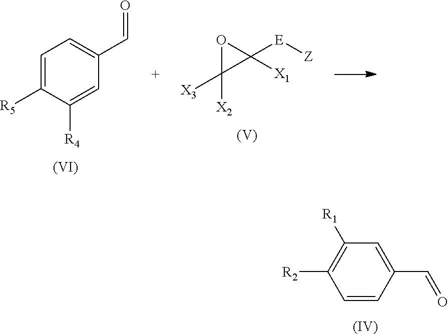

where for the compound of formula (VII):
   R₄ represents a chemical group selected from the group consisting of —OCH₃, —OCH₂CH₃ and —OH;
   R₅ represents a chemical group selected from the group consisting of —OCH₃ and —OH; and
   provided that R₄ or R₅ is —OH;
where for the compound of formula (VI):
   E represents a divalent C1-C12 hydrocarbon group optionally comprising one or more heteroatoms; and
   X₁, X₂, X₃, which may be identical or different, represent a hydrogen atom, a C1-C6 alkyl or a C6-C14 aryl; and
   Z represents a nucleofugal group;
where for the compound of formula (V): R₁ and R₂ are as defined above.

The preferred forms of R₁, R₂, E, X₁, X₂ and X₃ also apply to the process for preparing a compound of formula (V) from compounds of formula (VI) and compounds of formula (VII).

Those skilled in the art know how to adapt this reaction (b) in order to obtain the preferred 1,3-dipolar compounds of formulae (IIIa) and (IIIa1).

The term “nucleofugal group” is understood to mean a leaving group. The Z group may be selected from chlorine, bromine, iodine, fluorine, the mesylate group, the tosylate group, the acetate group and the trifluoromethylsulfonate group. Preferably, Z is bromine or chlorine.

The phase transfer agent may be selected from phosphonium salts, ammonium salts and mixtures thereof. Preferentially, the phase transfer agent is tetrabutylammonium bromide.

Preferentially, the molar amount of phase transfer agent is from 0.01 to 1 molar equivalents, preferably from 0.05 to 0.5 molar equivalents, relative to the molar amount of compound of formula (VI).

Preferentially, the process of the invention comprises, after the reaction (b), a step of recovery of the compound of formula (V).

The compounds of formula (VII) as defined above are commercially available from suppliers such as Sigma-Aldrich, Merck, etc. They may be obtained by chemical synthesis, or, in the case of vanillin, by extraction from vanilla pods or, in the case of isovanillin, by extraction from cassava, or else obtained from fermentation by microorganisms, in particular by fermentation proceeding from ferulic acid.

The compounds of formula (VI) may be commercially available or may be obtained by epoxidation of the corresponding haloalkene of formula (VIII) according to the reaction scheme below. The synthesis of a compound comprising an epoxide ring from its corresponding alkene is well known. For example, this epoxidation may be performed in the presence of a peracid such as meta-chloroperbenzoic acid, peracetic acid or performic acid. Another well-known technique is the use of dimethyldioxirane.

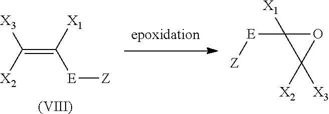

The compounds of formula (VIII) are commercially available from suppliers such as Sigma-Aldrich and ABCR.

A subject of the invention is also an elastomeric composition based on at least one polymer of the invention, that is to say on at least one diene polymer comprising one or more pendent groups of formula (I), preferentially one or more pendent groups of formula (Ia), more preferentially still one or more pendent groups of formula (Ia1), on at least one reinforcing filler and on at least one chemical crosslinking agent.

Preferentially, the polymer of the invention which can be used in the composition is a diene elastomer. More preferentially still, the polymer is selected from the group of elastomers consisting of ethylene/propylene/diene monomer copolymers, butyl rubbers, natural rubber, synthetic polyisoprenes, polybutadienes, butadiene copolymers, isoprene copolymers, and mixtures of these elastomers.

In this composition, the polymer(s) of the invention may be used in combination with any type of synthetic elastomer other than a diene elastomer, indeed even with polymers other than elastomers, such as for example thermoplastic polymers. Preferentially, in the case of a mixture with at least one other polymer, the diene polymer comprising at least one pendent group of formula (I) is the predominant polymer in the elastomeric composition. It should be noted that the improvement in the properties of the elastomeric composition according to the invention will be greater as the proportion of said additional polymer(s) in the elastomeric composition according to the invention becomes lower.

As seen above, another component of the elastomeric composition according to the invention is a reinforcing filler.

Use may be made of any type of “reinforcing” filler known for its abilities to reinforce an elastomeric composition which can be used in particular for the manufacture of tyres, for example an organic filler, such as carbon black, a reinforcing inorganic filler, such as silica, or else a mixture of these two types of fillers. When a reinforcing inorganic filler such as a silica is used, it will be combined with a coupling agent in a known manner.

Advantageously, the reinforcing filler is selected from carbon black, a reinforcing inorganic filler, preferably a silica, and mixtures thereof.

Suitable carbon blacks include all carbon blacks, notably the blacks conventionally used in tyres or their treads. Among the latter, mention will be made more particularly of the reinforcing carbon blacks of the 100, 200 and 300 series, or the blacks of the 500, 600 or 700 series (ASTM D-1765-2017 grades), for instance the N115, N134, N234, N326, N330, N339, N347, N375, N550, N683 and N772 blacks.

The term “reinforcing inorganic filler” should be understood here as meaning any inorganic or mineral filler, whatever its colour and its origin (natural or synthetic), also known as “white filler”, “clear filler” or even “non-black filler”, in contrast to carbon black, which is capable of reinforcing, by itself alone, without means other than an intermediate coupling agent, an elastomeric composition intended for the manufacture of tyres. In a known manner, some reinforcing inorganic fillers may in particular be characterized by the presence of hydroxyl (—OH) groups at their surface.

Suitable in particular as reinforcing inorganic fillers are mineral fillers of the siliceous type, preferentially silica (SiO₂), or of the aluminous type, in particular alumina (Al₂O₃).

The silica used may be any reinforcing silica known to those skilled in the art, in particular any precipitated or fumed silica with a BET specific surface area and also a CTAB specific surface area both of less than 450 m²/g, preferably within a range extending from 30 to 400 m²/g.

Use may be made of any type of precipitated silica, in particular highly dispersible precipitated silicas (HDS, for “highly dispersible silicas”). These precipitated silicas, which may or may not be highly dispersible, are well known to those skilled in the art. Mention may be made, for example, of the silicas described in patent applications WO 03/016215-A1 and WO 03/016387-A1. Among the commercial HDS silicas, use may notably be made of the Ultrasil® 5000GR and Ultrasil® 7000GR silicas from the company Evonik or the Zeosil® 1085GR, Zeosil® 1115 MP, Zeosil® 1165MP, Zeosil® Premium 200MP and Zeosil® HRS 1200 MP silicas from the company Solvay. Use may be made, as non-HDS silica, of the following commercial silicas: the Ultrasil® VN2GR and Ultrasil® VN3GR silicas from the company Evonik, the Zeosil® 175GR silica from the company Solvay or the Hi-Sil EZ120G(-D), Hi-Sil EZ160G(-D), Hi-Sil EZ200G(-D), Hi-Sil 243LD, Hi-Sil 210 and Hi-Sil HDP 320G silicas from the company PPG.

In the present disclosure, the BET specific surface area for the inorganic filler, in particular for the silica, is determined by gas adsorption using the Brunauer-Emmett-Teller method described in “The Journal of the American Chemical Society” (Vol. 60, page 309, February 1938), and more specifically according to a method adapted from the standard NF ISO 5794-1, appendix E, of June 2010 [multipoint (5 point) volumetric method—gas: nitrogen—degassing under vacuum: one hour at 160° C.—relative pressure p/po range: 0.05 to 0.17]. The CTAB specific surface area values were determined according to the standard NF ISO 5794-1, appendix G of June 2010. The process is based on the adsorption of CTAB (N-hexadecyl-N,N,N-trimethylammonium bromide) on the “outer” surface of the reinforcing filler.

In order to couple the reinforcing inorganic filler to the diene polymer, use may be made, in a well-known manner, of an at least bifunctional coupling agent (or bonding agent) intended to provide a satisfactory connection, of chemical and/or physical nature, between the inorganic filler (surface of its particles) and the diene elastomer.

As coupling agent, it is possible to use (symmetrical or asymmetrical) organosilane polysulfides, such as bis(3-triethoxysilylpropyl) tetrasulfide, abbreviated to TESPT, sold under the name Si69 by the company Evonik, or bis(triethoxysilylpropyl) disulfide, abbreviated to TESPD, sold under the name Si75 by the company Evonik, polyorganosiloxanes, mercaptosilanes, blocked mercaptosilanes, such as S-(3-(triethoxysilyl)propyl) octanethioate, sold by the company Momentive under the name NXT Silane. More preferentially, the organosilane is an organosilane polysulfide.

Preferentially, the reinforcing filler predominantly comprises at least one silica.

Another component of the elastomeric composition according to the invention is a crosslinking agent. The crosslinking agent allows the formation of covalent bonds between the elastomer chains, thereby conferring elastic properties thereon.

The crosslinking agent can be any type of system known to a person skilled in the art in the field of elastomeric compositions for tyres. It may in particular be based on sulfur or based on peroxides.

Preferentially, the crosslinking agent is based on sulfur; it is then called a vulcanization system. The sulfur can be provided in any form, in particular in the form of molecular sulfur or of a sulfur-donating agent. At least one vulcanization accelerator is also preferentially present, and, optionally, also preferentially, use may be made of various known vulcanization activators, such as zinc oxide, stearic acid or an equivalent compound, such as stearic acid salts, and salts of transition metals, guanidine derivatives (in particular diphenylguanidine), or else known vulcanization retarders.

The elastomeric compositions in accordance with the invention can also comprise all or some of the usual additives and processing aids known to a person skilled in the art and generally used in elastomeric compositions especially for tyres, in particular treads, such as, for example, plasticizers (such as plasticizing oils and/or plasticizing resins), non-reinforcing fillers, pigments, protective agents, such as antiozone waxes, chemical antiozonants, antioxidants, anti-fatigue agents or reinforcing resins (such as described, for example, in application WO 02/10269).

The elastomeric compositions are manufactured in appropriate mixers, using two successive phases of preparation:
a first phase of thermomechanical working or kneading (“non-productive” phase) conducted at a maximum temperature within a range extending from 110° C. to 200° C., preferably from 130° C. to 185° C., for a duration of generally within a range extending from 2 to 10 minutes,
a second phase of mechanical working (“productive” phase), which is carried out in an external mixer, such as an open mill, after cooling the mixture obtained during the first non-productive phase down to a lower temperature, typically of less than 120° C., for example within a range extending from 40° C. to 100° C. The crosslinking agent is then incorporated and the combined mixture is mixed for a few minutes, for example within a range extending from 5 to 15 min.

Generally, all the base constituents of the elastomeric composition according to the invention, with the exception of the chemical crosslinking agent, namely the reinforcing filler(s) and the coupling agent, if appropriate, are intimately incorporated, by kneading, into the polymer bearing along its chain one or more pendent groups of formula (I) or preferred forms thereof during the first “non-productive” phase, that is to say that at least these various base constituents are introduced into the mixer and are thermomechanically kneaded, in one or more steps, until the maximum temperature within a range extending from 110° C. to 200° C., preferably from 130° C. to 185° C., is reached.

On conclusion of the second working phase, the final elastomeric composition thus obtained can subsequently be calendered, for example in the form of a sheet or a slab, especially for characterization, or else extruded in the form of a rubber profiled element which can be used as semi-finished article for a tyre.

Another subject of the present invention is a semi-finished article for a tyre comprising at least one polymer of the invention as described above, including the preferred forms thereof, or capable of being obtained according to the process described above or at least one elastomeric composition as defined above. Preferably, the semi-finished article for a tyre is a tyre tread.

A subject of the invention is also a tyre comprising at least one polymer of the invention as described above, including the preferred forms thereof, or capable of being obtained according to the process described above or at least one elastomeric composition according to the invention as defined above or at least one semi-finished article for a tyre as described above.

The tyre according to the invention will preferentially be able to be selected from tyres intended to equip a two-wheeled vehicle, a passenger vehicle, or else a “heavy-duty” vehicle (that is to say, underground trains, buses, off-road vehicles, heavy road transport vehicles, such as trucks, tractors or trailers), or else aircraft, civil engineering vehicles, heavy agricultural vehicles or handling vehicles.

The examples which follow make it possible to illustrate the invention; however, the invention shall not be limited to these examples alone.

### EXAMPLES

### 1. Methods

### 1.1 Measurement of the Number-Average (Mn) and Weight-Average (Mw) Molar Masses and of the Polydispersity Index of the Elastomers

Size exclusion chromatography (SEC) is used. SEC makes it possible to separate macromolecules in solution according to their size through columns filled with a porous gel.

The macromolecules are separated according to their hydrodynamic volume, the bulkiest being eluted first.

Without being an absolute method, SEC makes it possible to comprehend the distribution of the molar masses of an elastomer. The various number-average molar masses (Mn) and weight-average molar masses (Mw) may be determined from commercial standards and the polydispersity index (PDI=Mw/Mn) may be calculated via a “Moore” calibration.

### Preparation of the Elastomer Sample to be Tested

There is no specific treatment of the elastomer sample before analysis. The latter is simply dissolved, at a concentration of approximately 1 g/l, in chloroform or in the following mixture: tetrahydrofuran+1 vol % of diisopropylamine+1 vol % of triethylamine+1 vol % of distilled water (vol %=% by volume). The solution is then filtered through a filter with a porosity of 0.45 μm before injection.

### SEC Analysis

The apparatus used is a Waters Alliance chromatograph. The elution solvent is the following mixture: tetrahydrofuran+1 vol % of diisopropylamine+1 vol % of triethylamine or chloroform, according to the solvent used for the dissolution of the elastomer. The flow rate is 0.7 ml/min, the temperature of the system is 35° C. and the analysis time is 90 min. A set of four Waters columns in series, having the commercial names Styragel HMW7, Styragel HMW6E and two Styragel HT6E, is used.

The volume of the solution of the elastomer sample injected is 100 μl. The detector is a Waters 2410 differential refractometer with a wavelength of 810 nm. The software for processing the chromatographic data is the Waters Empower system. The calculated average molar masses are relative to a calibration curve produced from PSS Ready Cal-Kit commercial polystyrene standards.

### 1.2. Characterizations of the Molecules

The structural analysis and the determination of the molar purities of the molecules synthesized are performed by NMR analysis. The spectra are acquired on a Bruker Avance 3 400 MHz spectrometer equipped with a “5 mm BBFO Z-grad broad band” probe. The quantitative ¹H NMR experiment uses a 300 single pulse sequence and a repetition time of 3 seconds between each of the 64 acquisitions. The samples are dissolved in a deuterated solvent, deuterated dimethyl sulfoxide (DMSO) unless otherwise indicated. The deuterated solvent is also used for the “lock” signal. For example, calibration is performed on the signal of the protons of the deuterated DMSO at 2.44 ppm relative to a TMS reference at 0 ppm. The ¹H NMR spectrum coupled with the 2D ¹H/PC HSQC and ¹H/PC HMBC experiments enable the structural determination of the molecules (cf. assignment tables). The molar quantifications are carried out from the quantitative 1D ¹H NMR spectrum.

The analysis by mass spectrometry is carried out by a direct-injection electrospray ionization method (DI/ESI). The analyses were carried out on a Bruker HCT spectrometer (flow rate 600 μl/min, pressure of the nebulizer gas 10 psi, flow rate of the nebulizer gas 4 l/min).

1.3. Characterizations of the Compounds Grafted onto the Diene Elastomers

The determination of the molar content of the compounds grafted onto the diene elastomers is performed by an NMR analysis. The spectra are acquired on a Bruker 500 MHz spectrometer equipped with a “5 mm BBFO Z-grad CryoProbe” probe. The quantitative ¹H NMR experiment uses a 300 single pulse sequence and a repetition time of 5 seconds between each acquisition.

The samples are dissolved in deuterated chloroform (CDCl₃) for the purpose of obtaining a “lock” signal. 2D NMR experiments made it possible to confirm the nature of the grafted unit by means of the chemical shifts of the carbon atoms and protons.

### 1.4. Dynamic Properties of the Elastomeric Compositions

The dynamic properties G* and tan(δ)ₘₐₓ are measured on a viscosity analyser (Metravib VA4000) according to the standard ASTM D5992-96. The response of a sample of vulcanized composition (cylindrical test specimen 4 mm thick and 400 mm² in cross section), subjected to a simple alternating sinusoidal shear stress, at a frequency of 10 Hz, at a temperature of 60° C., is recorded. A strain amplitude sweep is carried out from 0.1% to 100% peak-peak (outward cycle) and then from 100% to 0.1% peak-peak (return cycle).

The results utilized are the complex dynamic shear modulus G* at 50% strain (G*_{50%} return) and the dynamic loss factor tan(δ) at 60° C. For the return journey, the value of the complex dynamic shear modulus G* at 50% strain, denoted G*_{50% return at 60° C.}, and the maximum value of the dynamic loss factor tan(δ) observed, denoted tan(δ)_{max at 60° C.}, are recorded.

The results are shown in base 100, the arbitrary value 100 being assigned to the control in order to calculate and subsequently compare tan(δ)_{max at 60° C.} and G*_{50% return at 60° C.}.

For tan(δ)_{max at 60° C.}, the value in base 100 for the sample to be tested is calculated according to the operation: (tan(δ)_{max at 60° C.} value of the sample to be tested/tan(δ)_{max at 60° C.} value of the control)×100. In this way, a result of less than 100 indicates a decrease in the hysteresis, which corresponds to an improvement in the rolling resistance performance.

For G*_{50% return at 60° C.}, the value in base 100 for the sample to be tested is calculated according to the operation: (G*_{50% return at 60° C.} value of the sample to be tested/G*_{50% return at 60° C.} value of the control)×100. In this way, a result of greater than 100 indicates an improvement in the complex dynamic shear modulus G*_{50% return at 60° C.}, which corroborates an improvement in the stiffness of the material.

### 1.5. Tensile Test

These tensile tests make it possible to determine the elasticity stresses. Unless otherwise indicated, they are performed in accordance with the French standard NF T46-002 of September 1988. Processing the tensile recordings also makes it possible to plot the curve of modulus as a function of the elongation. At first elongation, the nominal secant modulus, calculated by normalizing to the initial cross section of the test specimen, (or apparent stress, in MPa) is measured at 100% elongation, denoted MSA100, and at 300% elongation, denoted MSA300. All these tensile measurements are performed under the standard temperature conditions (23±2° C.) according to the standard NF T46-002 and at a temperature of 100° C.

The MSA300/MSA100 ratio is the reinforcement index. The value in base 100 for the sample to be tested is calculated according to the operation: (MSA300/MSA100 value of the sample to be tested/MSA300/MSA100 value of the control)×100. In this way, a result of greater than 100 indicates an improvement in the reinforcement index.

### 2. Synthesis of the Compounds

### 2.1. Synthesis of 3-methoxy-4-(oxiran-2-ylmethoxy)benzonitrile oxide (Compound A)

Compound A is synthesized according to the following reaction scheme:

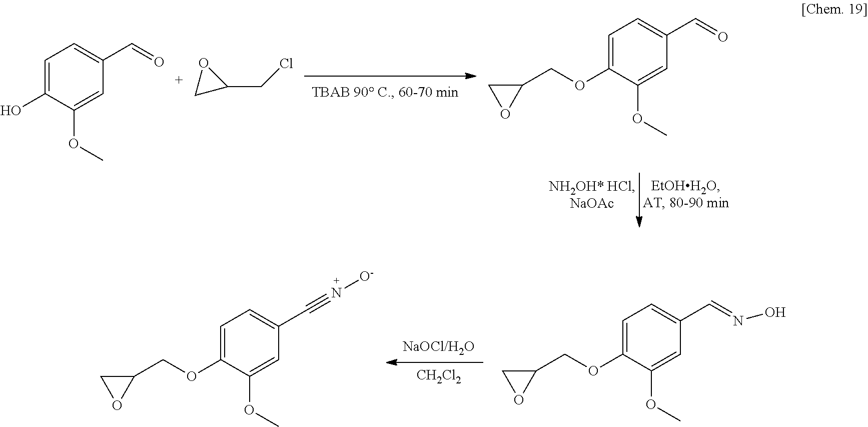

The vanillin is obtained from the company Sigma-Aldrich, which sells it under the reference “W310700-1KG”.

### 2.1.1. Step 1: Synthesis of 3-methoxy-4-(oxiran-2-ylmethoxy)benzaldehyde

To a solution of vanillin (20 g; 131 mmol) in epichlorohydrin (278 ml; 3.56 mol, i.e. 27 eq. (eq.=molar equivalent)) is added tetrabutylammonium bromide (4.24 g; 13.15 mmol, i.e. 0.1 eq.). The reaction medium is then stirred for 60-70 minutes at a temperature of 90° C. After returning to ambient temperature, the reaction mixture is diluted with ethyl acetate (150 ml), washed with brine (3×75 ml) and lastly with distilled water (75 ml). The organic phase is then separated, dried over sodium sulfate and evaporated under reduced pressure (T bath=50° C.; 13 mbar). The oil obtained is triturated with ice-cold isopropyl alcohol (i-PrOH) (50 ml), allowing rapid crystallization. The precipitate is filtered off and washed with ice-cold i-PrOH (3×35 ml); and then dried in air.

A white solid (23.16 g; 111 mmol) is obtained with a yield of 85%. The molar purity is greater than 90% (¹H NMR).

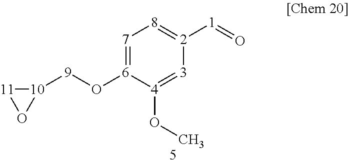

TABLE 1

| No. | δ ¹H (ppm) | δ ¹³C (ppm) |
|---|---|---|
| 1 | 9.80 | 190.9 |
| 2 | / | 130.6 |
| 3 | 7.36 | 109.4 |
| 4 | / | 149.9 |
| 5 | 3.88 | 56.0 |
| 6 | / | 153.3 |
| 7 | 6.97 | 112.2 |
| 8 | 7.38 | 126.5 |
| 9 | 4.04 and | 69.9 |
| | 4.33 | |
| 10 | 3.37 | 49.8 |
| 11 | 2.73 and | 44.7 |
| | 2.88 | |

### Solvent CDCl₃

### 2.1.2 Step 2: Synthesis of 3-methoxy-4-(oxiran-2-ylmethoxy)benzaldehyde oxime

To a suspension of 3-methoxy-4-(oxiran-2-ylmethoxy)benzaldehyde (4.253 g; 20.43 mmol) in ethanol (100 ml) is added, at ambient temperature (23° C.), a solution of sodium acetate (2.51 g; 30.6 mmol, i.e. 1.5 eq.) and of hydroxylamine hydrochloride (2.129 g; 30.6 mmol, i.e. 1.5 eq.) in distilled water (100 ml). After complete dissolution in 40-50 seconds, a slight exothermicity is observed within the reaction medium. A new precipitate forms within a few minutes. The reaction mixture is then stirred at ambient temperature for 90 minutes. Crushed ice (100 g) is then added and the medium is maintained under stirring until the crushed ice has completely melted. The precipitate is lastly filtered off, washed with an excess of water and dried in air. A white solid (3.604 g; 16.14 mmol; 79% yield) is obtained. The molar purity is greater than 89% (¹H NMR).

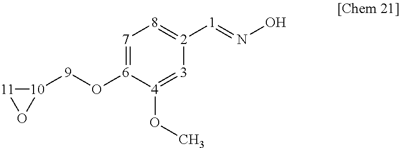

TABLE 2

| No. | δ ¹H (ppm) | δ ¹³C (ppm) |
|---|---|---|
| 1 | 8.00 | 150.2 |
| 2 | / | 126.0 |
| 3 | 6.95 | 121.5 |
| 4 | 6.86 | 113.6 |
| 5 | / | 149.9 |
| 6 | / | 150.0 |
| 7 | 7.17 | 108.9 |
| 8 | 3.84 | 56.0 |
| 9 | 4.00 and 4.22 | 70.2 |
| 10 | 3.33 | 50.1 |
| 11 | 2.69 and 2.84 | 44.9 |

Solvent: CDCl₃

### 2.1.3 Step 3: Synthesis of 3-methoxy-4-(oxiran-2-ylmethoxy)benzonitrile N-oxide

To a suspension of 3-methoxy-4-(oxiran-2-ylmethoxy)benzaldehyde oxime (10.15 g; 45.5 mmol) in dichloromethane (100 ml) cooled to 0-3° C. is added, dropwise, a solution of bleach (98.5 ml; 4% active chlorine) (bleach=sodium hypochlorite) over 20-25 minutes. The reaction medium is then stirred for 80-90 minutes between 0 and 5° C. The organic phase is then separated, washed with water (2×50 ml) and lastly evaporated under reduced pressure (T bath=25° C.; 10 mbar) to afford a beige solid. This solid is then redissolved in dichloromethane (˜100 ml). The solution obtained above is then filtered through a layer of SiO₂ (about 4-5 cm thick), eluting with dichloromethane (2×30 ml). The permeate is lastly concentrated under reduced pressure (T bath=25° C.; 10 mbar) to afford a white solid obtained with a yield of 71% (7.126 g; 32.2 mmol). The molar purity is 95% (¹H NMR).

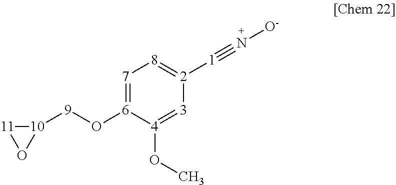

TABLE 3

| No. | δ ¹H (ppm) | δ ¹³C (ppm) |
|---|---|---|
| 1 | / | / |
| 2 | / | 106.1 |
| 3 | 7.04 | 125.8 |
| 4 | 6.87 | 114.0 |
| 5 | / | 150.7 |
| 6 | / | 150.0 |
| 7 | 6.92 | 115.0 |
| 8 | 3.82 | 56.2 |
| 9 | 3.98 and | 70.2 |
| | 4.27 | |
| 10 | 3.32 | 49.9 |
| 11 | 2.69 and | 44.7 |
| | 2.85 | |

Solvent: CDCl₃

### 2.2. Synthesis of 2-(glycidyloxy)-1-naphthonitrile oxide (Compound B)

2-(Glycidyloxy)-1-naphthonitrile oxide, compound B, is synthesized according to the procedure described in patent application US 2012/0046418 A1 paragraphs [0033] to [0037].

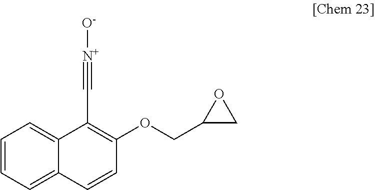 [SMILES: [O-][N+]#Cc1c(OCC2CO2)ccc2ccccc12]

### 2.3 Synthesis of 2,4,6-trimethyl-3-(oxiran-2-ylmethoxy)benzonitrile oxide (Compound C)

2,4,6-Trimethyl-3-(oxiran-2-ylmethoxy)benzonitrile oxide, compound C, is synthesized according to the reaction scheme and synthesis process described below and obtained from the examples of document WO2019102128:

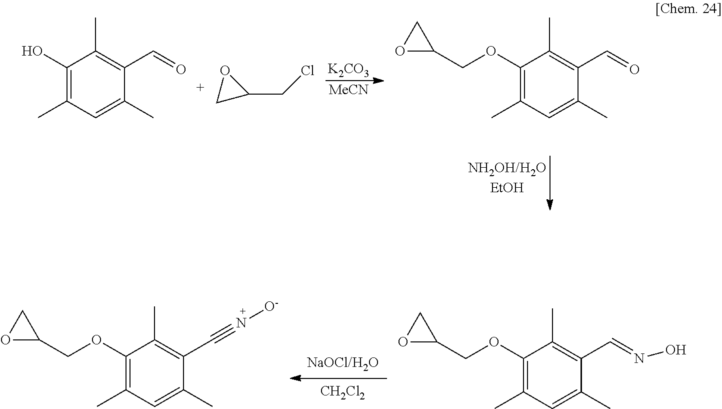

### 2.3.1. Synthesis of 2,4,6-trimethyl-3-(oxiran-2-ylmethoxy)benzaldehyde

To a mixture of 3-hydroxy-2,4,6-trimethylbenzaldehyde (40.00 g; 0.244 mol) and epichlorohydrin (56.35 g; 0.609 mol) in acetonitrile (100 ml) is added potassium carbonate (50.50 g; 0.365 mol). The reaction medium is stirred for 3 hours at 60° C. and is then stirred for 2.5-3 hours at 70° C. After returning to 40-50 C, the reaction mixture is diluted with a mixture of water (250 ml) and ethyl acetate (250 ml) and then maintained under stirring for 10 minutes.

The organic phase is separated and washed with water (4 times with 125 ml). The solvent is evaporated under reduced pressure (T bath 37° C.; 40 mbar). A red oil (66.43 g) is obtained. The byproduct of the reaction, 3,3′-((2-hydroxypropane-1,3-diyl)bis(oxy))bis(2,4,6-trimethylbenzaldehyde), is separated from 2,4,6-trimethyl-3-(oxiran-2-ylmethoxy)benzaldehyde by chromatography on a silica column (eluent: ethyl acetate/petroleum ether=1/4 by volume). After recovery of the fractions containing 2,4,6-trimethyl-3-(oxiran-2-ylmethoxy)benzaldehyde, the solvents are evaporated under reduced pressure (T bath 36° C.; 21 mbar). Petroleum ether (120 ml) is added to the residue and the suspension is maintained under stirring at −18° C. for 2 hours. The precipitate is filtered off, washed on the filter with petroleum ether (40/60) (3 times 25 ml) and lastly dried under atmospheric pressure at ambient temperature for 10-15 hours. A white solid (40.04 g; yield by mass of 75%) with a melting point of 52° C. is obtained. The molar purity is greater than 99% (¹H NMR).

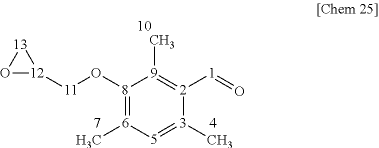

TABLE 4

| | δ ¹H (ppm) | δ ¹³C (ppm) |
|---|---|---|
| 1 | 10.37 | 193.3 |
| 2 | / | 131.1 |
| 3 | / | 132.8 |
| 4 | 2.4 | 19.2 |
| 5 | 6.94 | 131.3 |
| 6 | / | 136.3 |
| 7 | 2.2 | 16.1 |
| 8 | / | 153.4 |
| 9 | 1 | 135.7 |
| 10 | 2.4 | 11.7 |
| 11 | 3.50/4.00 | 73.4 |
| 12 | 3.29 | 49.6 |
| 13 | 2.60/2.76 | 42.9 |

Solvent DMSO

### 2.3.2 Synthesis of 2,4,6-trimethyl-3-(oxiran-2-ylmethoxy)benzaldehyde oxime

To a solution of 2,4,6-trimethyl-3-(oxiran-2-ylmethoxy)benzaldehyde (46.70 g; 0.212 mol) in ethyl alcohol (750 ml) is added, at ambient temperature, a solution of hydroxylamine (16.81 g; 0.254 mol, 50% in water, Aldrich) in ethyl alcohol (75 ml). The reaction medium is stirred for 3 hours at 23° C. (T bath). After evaporation of the solvent (T bath=24° C.; 35 mbar), petroleum ether (40/60) (150 ml) is added. The precipitate is filtered off and washed on the filter with petroleum ether (100 ml). The crude product is dissolved in a mixture of ethyl acetate (650 ml) and petroleum ether (650 ml) at ambient temperature and this solution is filtered through a layer of silica gel (Ø9 cm, 2.0 cm of SiO₂).

The solvents are evaporated (T bath=22-24° C.) and the 2,4,6-trimethyl-3-(oxiran-2-ylmethoxy)benzaldehyde oxime is dried under atmospheric pressure at ambient temperature. A white solid (43.81 g; yield by mass of 88%) with a melting point of 77° C. is obtained. The molar purity is greater than 99% (¹H NMR).

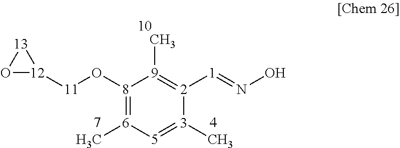

TABLE 5

| | δ ¹H (ppm) | δ ¹³C (ppm) |
|---|---|---|
| 1 | 8.2 | 147.3 |
| 2 | / | 129.1 |
| 3 | / | 129.2 |
| 4 | 2.18 | 20.1 |
| 5 | 6.85 | 130.2 |
| 6 | / | 130.3 |
| 7 | 2.15 | 15.7 |
| 8 | / | 153.1 |
| 9 | / | 131.7 |
| 10 | 2.18 | 13.1 |
| 11 | 3.48/3.96 | 73.3 |
| 12 | 3.27 | 49.6 |
| 13 | 2.60/2.76 | 42.8 |

Solvent DMSO

### 2.3.3 Synthesis of 2,4,6-trimethyl-3-(oxiran-2-ylmethoxy)benzonitrile oxide (compound C)

To a solution of 2,4,6-trimethyl-3-(oxiran-2-ylmethoxy)benzaldehyde oxime (17.00 g; 0.072 mol) in dichloromethane (350 ml) cooled to 3° C. is added, dropwise, an aqueous solution of NaOCl in water (62.9 g active Cl/l) (126 ml) over 10-15 minutes. The temperature of the reaction medium remains between 3° C. and 5° C. The reaction medium is subsequently stirred at a temperature of 3-5° C. for 1 hour. The aqueous phase is separated and extracted with dichloromethane (25 ml). The combined organic phases are washed with water (3 times 75 ml). The solvent is evaporated at reduced pressure (T bath=22° C., 35 mbar). Petroleum ether (40/60) (90 ml) is added to this residue and the suspension is maintained under stirring at ambient temperature for 10-12 hours. The precipitate is filtered off, washed on the filter with petroleum ether (3 times 30 ml) and lastly dried under atmospheric pressure at ambient temperature for 10-15 hours. A white solid (15.12 g, yield by mass of 90%) with a melting point of 63° C. is obtained. The molar purity is greater than 99% (¹H NMR).

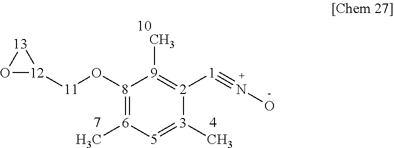

TABLE 6

| | δ ¹H (ppm) | δ ¹³C (ppm) |
|---|---|---|
| 1 | 2.59/2.76 | 43.0 |
| 2 | 3.28 | 49.6 |
| 3 | 3.51/4.03 | 73.5 |
| 4 | / | 153.0 |
| 5 | | 136.3 |
| 6 | 2.27 | 14.3 |
| 7 | / | 111.7 |
| 8 | / | |
| 9 | / | 134.4 |
| 10 | 2.18 | 15.9 |
| 11 | 7.01 | 129.9 |
| 12 | / | 134.0 |
| 13 | 2.27 | 19.5 |

### 3. Production of the Modified Diene Elastomers

3.1 Natural Rubber Modified with Compound A (Polymer According to the Invention)

0.98 phr of 3-methoxy-4-(oxiran-2-ylmethoxy)benzonitrile oxide (i.e. a molar fraction of 0.3 mol %), compound A obtained according to the process described in paragraph 2.1, with an NMR purity greater than 89 mol %, are incorporated into 100 g of natural rubber on an open mill (external mixer at 30° C.). The mixture is homogenized fifteen times on this mill, then formed into slabs, before undergoing a heat treatment at 100° C. for 10 min under a press at a pressure of 10 bar. Analysis by ¹H NMR made it possible to determine a molar degree of grafting of less than 0.100 mol % with a molar grafting yield of less than 33%.

3.2 Natural Rubber Modified with Compound B

1.06 phr of 2-(glycidyloxy)-1-naphthonitrile oxide (i.e. a molar fraction of 0.3 mol %), with an NMR purity of 95 mol %, compound B obtained according to the process of paragraph 2.2, are incorporated into 100 g of natural rubber on an open mill (external mixer at 30° C.). The mixture is homogenized fifteen times on this mill, then formed into slabs, before undergoing a heat treatment at 100° C. for 10 min under a press at a pressure of 10 bar. Analysis by ¹H NMR made it possible to determine a molar degree of grafting of 0.162 mol % with a molar grafting yield of 54%.

3.3 Natural Rubber Modified with Compound C

1.03 phr of 2,4,6-trimethyl-3-(oxiran-2-ylmethoxy)benzonitrile oxide (i.e. a molar fraction of 0.3 mol %), with an NMR purity of 99 mol %, compound C obtained according to the process of paragraph 2.3, are incorporated into 100 g of natural rubber on an open mill (external mixer at 30° C.). The mixture is homogenized fifteen times on this mill, then formed into slabs, before undergoing a heat treatment at 100° C. for 10 min under a press at a pressure of 10 bar. Analysis by ¹H NMR made it possible to determine a molar degree of grafting of 0.070 mol % with a molar grafting yield of 23%.

3.4 Synthetic Polyisoprene Modified with Compound A (Polymer According to the Invention)

0.98 phr of 3-methoxy-4-(oxiran-2-ylmethoxy)benzonitrile oxide (i.e. a molar fraction of 0.3 mol %), compound A obtained according to the process described in paragraph 2.1, with an NMR purity greater than 89 mol %, are incorporated into 100 g of synthetic polyisoprene (containing 99.35% by weight of cis-1,4-isoprene units and 0.65% by weight of 3,4-isoprene units; Mn=375 000 g/mol and PDI=3.6, measured according to the method described above) on an open mill (external mixer at 30° C.). The mixture is homogenized fifteen times on this mill, then formed into slabs, before undergoing a heat treatment at 100° C. for 10 min under a press at a pressure of 10 bar. Analysis by ¹H NMR made it possible to determine a molar degree of grafting of 0.150 mol % with a molar grafting yield of 50%.

3.5 Synthetic Polyisoprene Modified with Compound B

1.06 phr of 2-(glycidyloxy)-1-naphthonitrile oxide (i.e. a molar fraction of 0.3 mol %), with an NMR purity of 95 mol %, compound B obtained according to the process of paragraph 2.2, are incorporated into 100 g of synthetic polyisoprene (containing 99.35% by weight of cis-1,4-isoprene units and 0.65% by weight of 3,4-isoprene units; Mn=375 000 g/mol and PDI=3.6, measured according to the method described above) on an open mill (external mixer at 30° C.). The mixture is homogenized fifteen times on this mill, then formed into slabs, before undergoing a heat treatment at 100° C. for 10 min under a press at a pressure of 10 bar. Analysis by ¹H NMR made it possible to determine a molar degree of grafting of 0.145 mol % with a molar grafting yield of 48%.

3.6 Synthetic Polyisoprene Modified with Compound C

1.03 phr of 2,4,6-trimethyl-3-(oxiran-2-ylmethoxy)benzonitrile oxide (i.e. a molar fraction of 0.3 mol %), with an NMR purity of 99 mol %, compound C obtained according to paragraph 2.3, are incorporated into 100 g of synthetic polyisoprene (containing 99.35% by weight of cis-1,4-isoprene units and 0.65% by weight of 3,4-isoprene units; Mn=375 000 g/mol and PDI=3.6, measured according to the method described above) on an open mill (external mixer at 30° C.). The mixture is homogenized fifteen times on this mill, then formed into slabs, before undergoing a heat treatment at 100° C. for 10 min under a press at a pressure of 10 bar. Analysis by ¹H NMR made it possible to determine a molar degree of grafting of 0.200 mol % with a molar grafting yield of 67%.

### 4. Ingredients Used in the Elastomeric Compositions

(1) Silica, Zeosil 1165MP, sold by Solvay;
(2) Bis[3-(triethoxysilyl)propyl]tetrasulfide (TESPT) silane, sold by Evonik under the reference Si69;
(3) Carbon black of N234 grade, sold by Cabot Corporation;
(4) N-(1,3-Dimethylbutyl)-N-phenyl-para-phenylenediamine, sold by Flexsys under the reference Santoflex 6-PPD;
(5) 2,2,4-Trimethyl-1,2-dihydroquinoline, sold by the company Flexsys;
(6) Zinc oxide (industrial grade), sold by the company Umicore;
(7) Stearin, Pristerene 4031, sold by the company Uniqema;
(8) N-Cyclohexyl-2-benzothiazolesulfenamide, sold by Flexsys under the reference Santocure CBS;
(9) Natural rubber modified with compound B, obtained according to the process described in paragraph 3.2;
(10) Natural rubber modified with compound C, obtained according to the process described in paragraph 3.3;
(11) Natural rubber modified with compound A, obtained according to the process described in paragraph 3.1;
(12) Synthetic polyisoprene modified with compound B, obtained according to the process described in paragraph 3.5;
(13) Synthetic polyisoprene modified with compound C, obtained according to the process described in paragraph 3.6;
(14) Synthetic polyisoprene modified with compound A, obtained according to the process described in paragraph 3.4.

### 5. Test 1

The aim of this test is to show the improvement in performance compromise of an elastomeric composition comprising natural rubber modified with compound A (composition C3, according to the invention) compared to a control elastomeric composition (composition T1) and to two comparative elastomeric compositions (compositions C1 and C2).

The contents of the various constituents of these compositions, expressed in phr, part by weight per hundred parts by weight of elastomer, are presented in Table 7.

TABLE 7

| | T1 | C1 | C2 | C3 |
|---|---|---|---|---|
| Unmodified natural rubber | 100 | (—) | (—) | (—) |
| Natural rubber modified with | (—) | 100 | (—) | (—) |
| compound B (9) | | | | |
| Natural rubber modified with | (—) | (—) | 100 | (—) |
| compound C (10) | | | | |
| Natural rubber modified with | (—) | (—) | (—) | 100 |
| compound A (11) | | | | |
| Reinforcing filler (1) | 55 | 55 | 55 | 55 |
| Coupling agent (2) | 5.5 | 5.5 | 5.5 | 5.5 |
| Carbon black (3) | 3 | 3 | 3 | 3 |
| Antioxidant (4) | 1.5 | 1.5 | 1.5 | 1.5 |
| TMQ (5) | 1 | 1 | 1 | 1 |
| Paraffin | 1 | 1 | 1 | 1 |
| ZnO (6) | 2.7 | 2.7 | 2.7 | 2.7 |
| Stearic acid (7) | 2.5 | 2.5 | 2.5 | 2.5 |
| CBS (8) | 1.63 | 1.63 | 1.63 | 1.63 |
| Sulfur | 1.33 | 1.33 | 1.33 | 1.33 |

The elastomeric compositions T1 and C1 to C3 are prepared in the following manner: the natural rubber modified with compound B or modified with compound C or modified with compound A or the unmodified natural rubber is introduced into an 85 cm³ Polylab internal mixer, filled to 70%, the initial vessel temperature of which is approximately 100° C.

Next, for each of the elastomeric compositions, the reinforcing filler(s), the agent for coupling the filler with the diene elastomer and then, after kneading for one to two minutes, the various other ingredients, with the exception of the vulcanization system, are introduced. Thermomechanical working (non-productive phase) is then carried out in a step which lasts in total approximately from 5 to 6 minutes, until a maximum dropping temperature of 160° C. is reached.

The mixture thus obtained is recovered and cooled and the vulcanization system (sulfur and the sulfenamide-type accelerator) is then added on an external mixer (homofinisher) at 25° C., the whole being mixed (productive phase) for approximately 5 to 6 minutes.

The elastomeric compositions thus obtained are subsequently calendered in the form of slabs (thickness of 2 to 3 mm) for measurement of their physical or mechanical properties.

The rubber properties of these compositions are measured after curing at 150° C. for 30 minutes. The results obtained are given in Table 8.

TABLE 8

| Compositions | T1 | C1 | C2 | C3 |
|---|---|---|---|---|
| MA300/MA100 at 23° C. (base 100) | 100 | 125 | 99 | 133 |
| MA300/MA100 at 100° C. (base 100) | 100 | 125 | 107 | 129 |
| Tan (δ)_{max at 60° C.} (base 100) | 100 | 74 | 93 | 65 |
| G*_{50% return at 60° C.} (base 100) | 100 | 101 | 99 | 104 |

The elastomeric composition of the invention C3 simultaneously exhibits, compared to the control T1 and comparative C1 and C2 elastomeric compositions, a significant improvement in the reinforcement index (MA300/M100) and an improvement in the rolling resistance/stiffness performance compromise (reduction in tan(δ)_{max at 60° C.} and increase in G*_{50% return at 60° C.}).

### 5. Test 2

The aim of this test is to show the improvement in performance compromise of an elastomeric composition comprising a synthetic polyisoprene modified with compound A (composition C6 according to the invention) compared to a control elastomeric composition (composition T2) and to two comparative elastomeric compositions (compositions C4 and C5).

The contents of the various constituents of these elastomeric compositions, expressed in phr, part by weight per hundred parts by weight of elastomer, are presented in Table 9.

TABLE 9

| | T2 | C4 | C5 | C6 |
|---|---|---|---|---|
| Unmodified synthetic polyisoprene | 100 | (—) | (—) | (—) |
| Synthetic polyisoprene modified | (—) | 100 | (—) | (—) |
| with compound B (12) | | | | |
| Synthetic polyisoprene modified | (—) | (—) | 100 | (—) |
| with compound C (13) | | | | |
| Synthetic polyisoprene modified | (—) | (—) | (—) | 100 |
| with compound A (14) | | | | |
| Reinforcing filler (1) | 55 | 55 | 55 | 55 |
| Coupling agent (2) | 5.5 | 5.5 | 5.5 | 5.5 |
| Carbon black (3) | 3 | 3 | 3 | 3 |
| Antioxidant (4) | 1.5 | 1.5 | 1.5 | 1.5 |
| TMQ (5) | 1 | 1 | 1 | 1 |
| Paraffin | 1 | 1 | 1 | 1 |
| ZnO (6) | 2.7 | 2.7 | 2.7 | 2.7 |
| Stearic acid (7) | 2.5 | 2.5 | 2.5 | 2.5 |
| CBS (8) | 1.63 | 1.63 | 1.63 | 1.63 |
| Sulfur | 1.33 | 1.33 | 1.33 | 1.33 |

The elastomeric compositions T2 and C4 to C6 are prepared according to the process described above for the elastomeric compositions T1 and C1 to C3.

The rubber properties of these elastomeric compositions are measured after curing at 150° C. for 30 minutes. The results obtained are given in Table 10.

TABLE 10

| Compositions | T2 | C4 | C5 | C6 |
|---|---|---|---|---|
| MA300/MA100 at 23° C. (base 100) | 100 | 124 | 124 | 154 |
| MA300/MA100 at 100° C. (base 100) | 100 | 116 | 112 | 152 |
| Tan (δ)_{max at 60° C.} (base 100) | 100 | 60 | 90 | 60 |
| G*_{50% return at 60° C.} (base 100) | 100 | 87 | 87 | 93 |

The elastomeric composition of the invention C6 simultaneously exhibits, compared to the control T2 and comparative C4 and C5 elastomeric compositions, a significant improvement in the reinforcement index (MA300/M100) and an improvement in the rolling resistance/stiffness performance compromise (reduction in tan(δ)_{max at 60° C.} and increase in G*_{50% return at 60° C.}).

1.-15. (canceled)

16. A polymer comprising one or more diene units and bearing along a main polymer chain one or more pendant groups of the following formula (I) 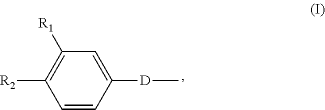
in which:
D represents a group of attachment to the main polymer chain;
R₁ represents a chemical group selected from the group consisting of —OCH₃, —OCH₂CH₃ and —OR₃;
R₂ represents a chemical group selected from the group consisting of —OCH₃ and —OR₃, provided that R₁ or R₂ is —OR₃; and
R₃ represents a chemical group of formula (II) 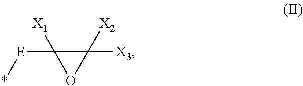
in which:
E represents a divalent C₁-C₁₂ hydrocarbon group optionally comprising one or more heteroatoms;
X₁, X₂, and X₃, which may be identical or different, represent a hydrogen atom, a C₁-C₆ alkyl or a C₆-C₁₄ aryl; and
* represents an attachment of the chemical group of formula (II) to the oxygen atom.

17. The polymer according to claim 16, wherein the one or more pendant groups are randomly distributed along the main polymer chain.

18. The polymer according to claim 16, wherein a molar content of the one or more pendant groups of formula (I) is within a range extending from 0.05% to 15%.

19. The polymer according to claim 16, wherein the polymer is a diene elastomer.

20. The polymer according to claim 16, wherein the polymer is selected from the group of elastomers consisting of ethylene/propylene/diene monomer copolymers, butyl rubbers, natural rubber, synthetic polyisoprenes, polybutadienes, butadiene copolymers, isoprene copolymers, and mixtures thereof.

21. The polymer according to claim 16, wherein R₁ represents a chemical group selected from the group consisting of —OCH₃ and —OCH₂CH₃, and R₂ is —OR₃.

22. The polymer according to claim 16, wherein E represents a C₁-C₁₂ alkanediyl.

23. The polymer according to claim 16, wherein X₁, X₂, and X₃, which may be identical or different, are selected from the group consisting of a hydrogen atom, C₁-C₆ alkyl and phenyl.

24. The polymer according to claim 16, wherein X₁, X₂, and X₃, which are identical, are each a hydrogen atom.

25. The polymer according to claim 16, wherein the one or more pendant groups of formula (I) is a pendant group of formula (Ia1)

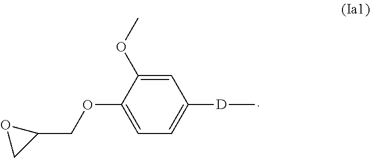

26. The polymer according to claim 16, wherein the attachment group D results from a reaction of a nitrile oxide function with a diene unit of the polymer.

27. A process for preparing the polymer according to claim 16, the process comprising a step of grafting an initial diene polymer with a compound from which is derived the pendant group of formula (I).

28. An elastomeric composition based on at least one polymer according to claim 16, on at least one reinforcing filler and on at least one crosslinking agent.

29. An elastomeric composition based on a polymer made by the process according to claim 27, on at least one reinforcing filler and on at least one crosslinking agent.

30. A semi-finished article for a tire comprising at least one polymer according to claim 16.

31. A semi-finished article for a tire comprising a polymer made by the process according to claim 27.

32. A semi-finished article for a tire comprising the elastomeric composition according to claim 28.

33. A tire comprising at least one polymer according to claim 16.

34. A tire comprising a polymer made by the process according to claim 27.

35. A tire comprising the elastomeric composition according to claim 28.

36. A tire comprising at least one semi-finished article for a tyre according to claim 31.
